(19) United States
(12) Patent Application Publication
(10) Pub. No.: US 2025/0019040 A1
(43) Pub. Date: Jan. 16, 2025

(54) MANUFACTURING OF UNDERWATER PRESSURE HULLS

(71) Applicant: DEEP R&D LTD, Bristol (GB)

(72) Inventors: Richard Goddard, Bristol (GB); Sebastien Samways, Bristol (GB); Tom Allison, Bristol (GB); William Laws, Bristol (GB); Chris Burden, Bristol (GB); Alfred Perring, Bristol (GB); Jeremy Fisher, Bristol (GB); Craig Freshwater, Bristol (GB); Connel Treble, Bristol (GB); Ewan Brown, Bristol (GB)

(73) Assignee: DEEP R&D LTD, Bristol (GB)

(21) Appl. No.: 18/771,545

(22) Filed: Jul. 12, 2024

(30) Foreign Application Priority Data
Jul. 14, 2023 (GB) 2310833.5

(51) Int. Cl. B63B 3/13; B33Y 10/00; B33Y 80/00; B63B 73/43; B63B 73/50

(52) U.S. Cl. CPC B63B 3/13; B63B 73/43; B63B 73/50; B33Y 10/00; B33Y 80/00

(57) ABSTRACT

The invention relates to a pressure hull for human occupancy, which is manufactured using an additive manufacturing process. This results in increased structural integrity and safety for the occupants of the pressure hull.

### TECHNICAL FIELD

The present disclosure relates to pressure hulls for human occupancy, specifically those manufactured using additive manufacturing techniques, for underwater applications such as submarines and underwater habitats.

### BACKGROUND

Large pressure hulls, such as those used in submarines and underwater habitats, are traditionally fabricated from plates, forgings, and castings via processes such as forming and welding. This manufacturing process has several drawbacks. Firstly, it takes a long time to produce the finished product. There are only a few manufacturers who can perform ring forging at scales large enough, and their availability is often booked up years in advance. The ring forging process itself takes several months, and subsequent machining and welding, often at a different site, further adds to the total manufacturing time of the hull. In total, the manufacturing time of a pressure hull can take approximately one year (before it is even fitted out).

Another challenge in the manufacturing of pressure hulls is achieving even residual stress distributions in the finished product. When manufacturing forging, castings, or plates of the thickness necessary for a large pressure hull or a pressure hull designed to experience high pressures (such as pressures greater than 10 atm), it is very hard to control the temperature at the centre of the plates—the temperature at the centre can only be controlled via the surfaces, which is challenging. Hence as the centre of the plate, forging, or casting cools more slowly, it is substantially more difficult to achieve consistent through-material mechanical properties. Moreover, once a flat plate has been formed, subsequent forming into a curved shape further increases residual stresses. In addition, welds are needed to join the forged plates together. Welding introduces an uneven application of heat into the material resulting in geometrical deformations, residual stresses, and a ‘heat affected zone’, which is a phrase used to describe the material in close proximity to the weld whose mechanical properties are affected by the process. This results in an uneven distribution of residual stress, uneven mechanical properties, and imperfect geometry which greatly affects the ability of an external pressure vessel to resist elastic buckling.

A specific scenario where it is hard to avoid welding is illustrated in FIG. 1. Pressure hulls are generally cylindrical or spherical since these structures have inherent strength against applied pressures. A cylindrical pressure hull C is illustrated in FIG. 1. If an aperture is required in the curved surface, for example, for a window or an entrance hatch, these features (generally illustrated A in FIG. 1) usually require to be attached to planar surfaces. Traditionally, this is done by attaching a second cylinder B to the main body C of the hull. An end of the second cylinder B then provides a planar ring where the window/hatch A can be attached. However, the junction of the cylinders requires a cut and weld along complex curved paths D. The uneven application of heat in these complex weld geometries causes the cylinders to deform, reducing their ability to withstand external pressure and therefore increasing the design safety margins which are required. The traditional forming process does not permit the two cylinders to be made of one-piece and so it is challenging to avoid welding in this scenario. The adverse effects of this process are often mitigated via the use of over thick materials, or the use of additional ‘transition rings’ which increases the design complexity and adds bulk in unwanted places.

Pressure hulls have previously been made using Additive Manufacturing (AM) techniques (see Krohmann et al, “Experimental Studies of Additive Manufacturing for Subsea Enclosures”, Proceedings of the ASME 2022 41st International Conference on Ocean, Offshore and Artic Engineering, Jun. 5-10, 2022). However, these pressure hulls are used for housing small measuring equipment and are designed to float. The small size and high positive buoyancy render these pressure hulls unsuitable as pressure hulls for human occupation.

Large-scale Wire Arc Additive Manufacturing (WAAM) is known to be useful for manufacturing parts in the shipbuilding industry (see Bhatt et al, “Optimizing Multi-Robot Placements for Wire Arc Additive Manufacturing”, 2022 International Conference on Robotics and Automation, 23-27 May 2022, IEEE). However, these prior art solutions have not fully addressed the problems associated with the manufacturing of large pressure hulls for human occupancy, particularly in terms of achieving appropriate stress distributions properties and strong joints in the finished product. In particular, the known prior art does not address these issues for pressure hulls designed to experience external pressures in underwater situations.

### SUMMARY OF THE DISCLOSURE

According to a first aspect of the disclosure, a pressure hull for human occupancy is provided, which is manufactured by an additive manufacturing process. The pressure hull may comprise a hull wall and at least one aperture fitting formed integrally with the hull wall. The at least one aperture fitting may be formed as one piece with the hull wall in a single additive manufacturing process and may protrude outwardly from the hull wall. The at least one aperture fitting may bound an aperture in the hull wall.

In some embodiments, the pressure hull may further comprise hull stiffeners, at least one arranged between each pair of adjacent aperture fittings, wherein the hull stiffeners are welded to an outer surface of the hull wall. The aperture fittings may be arranged around a circumference of the pressure hull. At least one aperture fitting may comprise a ring-shaped surface configured to be fitted with an aperture component, such as a window, a blank, a hatch, a moonpool, penetrator plate, penetrator, or a connecting structure configured to connect to an aperture fitting of a second pressure hull and to allow human passage therebetween.

The pressure hull may comprise a hull wall including an inner layer and an outer layer coating at least a portion of the inner layer, wherein the inner layer comprises a first material and the outer layer comprises a second, different material. The inner layer may have a radial thickness of at least 15 mm, and the outer layer may have a radial thickness of at least 3 mm or at least 10 mm. The first material may comprise at least one of steel, titanium, or aluminium, and the second material may comprise a corrosion-resistant material, such as Inconel, Duplex Steel, or Super Duplex Steel. Both the inner layer and the outer layer may be configured to support the pressure hull structurally against an applied pressure and may be manufactured by the additive manufacturing process.

The pressure hull may have an internal diameter of at least 1 m and may have a cylindrical or spherical shape, wherein the cylindrical shape comprises hemispherical ends. The pressure hull may comprise at least three hull wall modules connected in series to enclose an interior volume of the pressure hull. The additive manufacturing process may be a wire arc additive manufacturing process.

According to a second aspect of the disclosure, a method of manufacturing a pressure hull for human occupancy by an additive manufacturing process is provided. The method may comprise depositing a first bead of a first material to form a portion of a hull wall of the pressure hull, wherein the first material comprises at least one of steel, aluminium, or titanium. The method may further comprise depositing a second bead of a second material adjacent to the first bead to form a portion of the structural wall of the pressure hull, wherein the second material may be different from or the same as the first material and may be a corrosion-resistant material, such as Inconel, Duplex Steel, or Super Duplex Steel.

The method may also include forming an aperture fitting integrally with the hull wall in a single manufacturing process, wherein the at least one aperture fitting may protrude outwardly from the hull wall and may bound an aperture in the hull wall. The method may further comprise forming a plurality of the aperture fittings and integrating hull stiffeners between each pair of adjacent aperture fittings after the additive manufacturing process by welding. The additive manufacturing technique may be Wire Arc Additive Manufacturing (WAAM).

According to a third aspect of the disclosure, a method of additive manufacturing is provided, comprising depositing, by an additive manufacturing process, a first metal and depositing, by the same additive manufacturing process, a second metal different from the first metal abutting the deposited first metal. The additive manufacturing process may comprise wire arc additive manufacturing, and the second metal may be a corrosion-resistant metal, such as Inconel, Duplex Steel, or Super Duplex Steel. The first metal may comprise steel, aluminium, or titanium.

### BRIEF DESCRIPTION OF THE DRAWINGS

Examples are described in more detail below with reference to the appended drawings.

FIG. 1 is a diagram of a prior art pressure hull.

FIG. 2 is a view of a pressure hull for human occupancy.

FIG. 3 is cross-section of aperture fitting integral with the hull wall.

FIG. 4 is a cross-section of an aperture in the hull wall with a reinforcing rib and bosses for attachment of internal components.

FIG. 5 is a cross-section of the hull wall, comprising an inner layer and an outer layer.

FIG. 6 is a cross-section of the aperture fitting, comprising an inner layer and an outer layer.

FIG. 7 is a view of hull stiffeners attached to the hull wall between aperture fittings.

FIG. 8 is a flowchart illustrating a method of manufacturing a pressure hull using additive manufacturing.

FIG. 9 is a diagram illustrating features of the manufacturing of an end-cap module.

FIG. 10 shows an arrangement of robotic arms for manufacturing the pressure hull by WAAM.

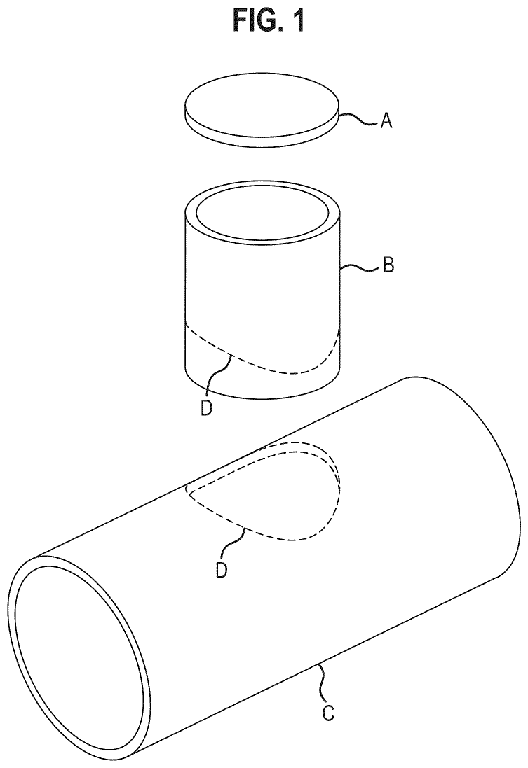

### DETAILED DESCRIPTION

The detailed description set forth below provides information and examples of the disclosed technology with sufficient detail to enable those skilled in the art to practice the disclosure.

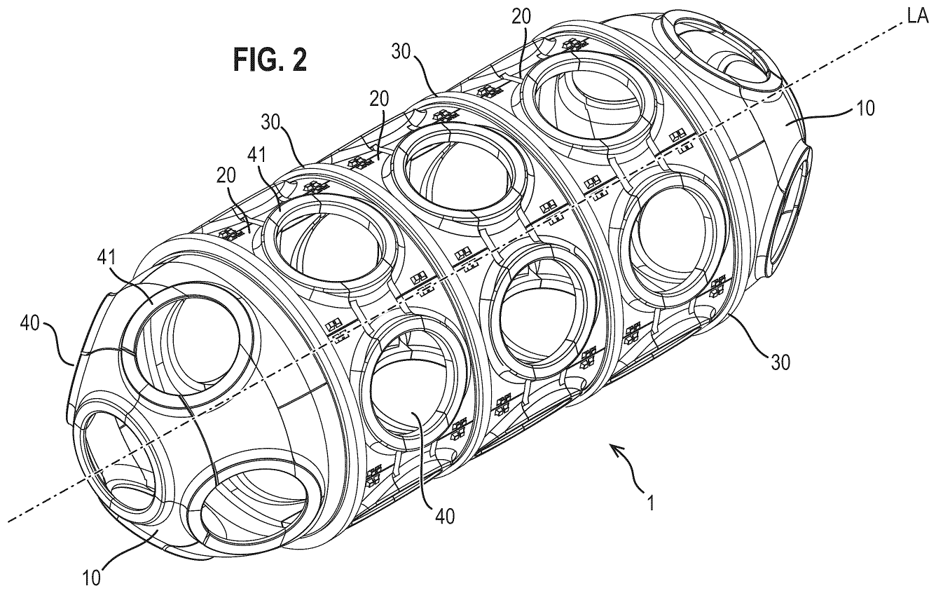

FIG. 2 illustrates a pressure hull 1 for human occupancy. The pressure hull 1 is for use underwater against an external pressure. The pressure hull 1 includes a hull wall 100. The hull wall 100 provides a structural barrier to protect the occupants of the underwater habitat against an external pressure. The pressure hull 1 can be used in submarines or underwater habitats, submersibles, diving bells, or other human occupied external pressure vessel.

The pressure hull 1 is manufactured using additive manufacturing techniques, such as Wire Arc Additive Manufacturing (WAAM). Additive manufacturing techniques, especially WAAM allow for the creation of complex shapes and structures with reduced material waste and increased accuracy. In particular, the additive nature of AM processes allows a more consistent application of heat and more consistent cooling through the thickness of the material. Moreover, the hull wall can be formed directly in a curved shape so there is no need for additional mechanical working or forming which can produce elevated and uneven residual stressed in the material. Any stresses produced as deposited beads of the AM cool are much more uniformly distributed throughout the wall, especially thick walls. The more favourable distribution of global residual stresses within the hull structure contribute to the increased structural integrity and safety of the pressure hull.

The WAAM process involves the use of an electric arc as a heat source to melt a metal wire, which is then deposited layer by layer to form the desired shape of the pressure hull. This process allows for the accurate and efficient manufacturing of the pressure hull components, including the hull wall, aperture fittings, and other integral structures. The WAAM process may comprise several steps, including the deposition of a first bead of a first material, such as steel, aluminium, or titanium, to form a portion of the hull wall of the pressure hull. Subsequently, a second bead of a second material, which can be different from or the same as the first material, may be deposited adjacent to the first bead to form a portion of the structural wall of the pressure hull. The second material may be a corrosion-resistant material, such as Inconel, Duplex Steel, or Super Duplex Steel, which contributes to the structural support and corrosion resistance of the pressure hull.

The hull wall 100 shown in FIG. 2 is made of hull wall modules 10 and 20, joined by mating rings 30 to enclose an interior volume 2. A modular configuration allows for expandable and customizable pressure hulls to thereby accommodate various underwater applications and mission requirements. The pressure hull comprises at least two hull wall modules 10, 20 connected in series to enclose interior volume 2 of the pressure hull 1. In other embodiments, the hull wall 100 may be of a single, unitary construction rather than the modular variant illustrated.

The hull wall 100 shown in FIG. 2 is cylindrical in shape and comprises hemispherical ends or torispherical ends. In general, hull walls 100 are cylindrical or spherical in shape, since these shapes are optimal for withstanding pressure. Alternatively, the hull wall may have a tubular or ellipsoidal shape or other non-circular geometries, depending on the specific application and design requirements. Hemispherical ends may be used for vessels primarily intended to withstand external pressure whereas torispherical ends may be used for vessels primarily designed to withstand internal pressures only.

The hull wall of the pressure hull has a radial thickness of at least 40 mm, providing sufficient structural support and protection for the occupants. The radial thickness is generally between 50 mm and 80 mm, depending on the specific application and design requirements.

The pressure hull has an internal diameter of 5 m. However, in other examples it has an internal diameter of at least 1 m, providing sufficient space for human occupancy. The internal diameter may be at least 2 m or 4 m, depending on the specific application and design requirements.

As shown in FIG. 2, the hull wall 100 includes apertures 40 therethrough. The apertures can be fitted with a variety of inserts (otherwise called aperture components) such as viewports/windows, moonpools, blanks (opaque plates that simply cover the apertures), escape hatches, penetrator plates, penetrators, and connecting structures configured to connect to apertures of a second pressure hull and allow human passage therebetween. Each penetrator plate may comprise one or more through holes for penetrators.

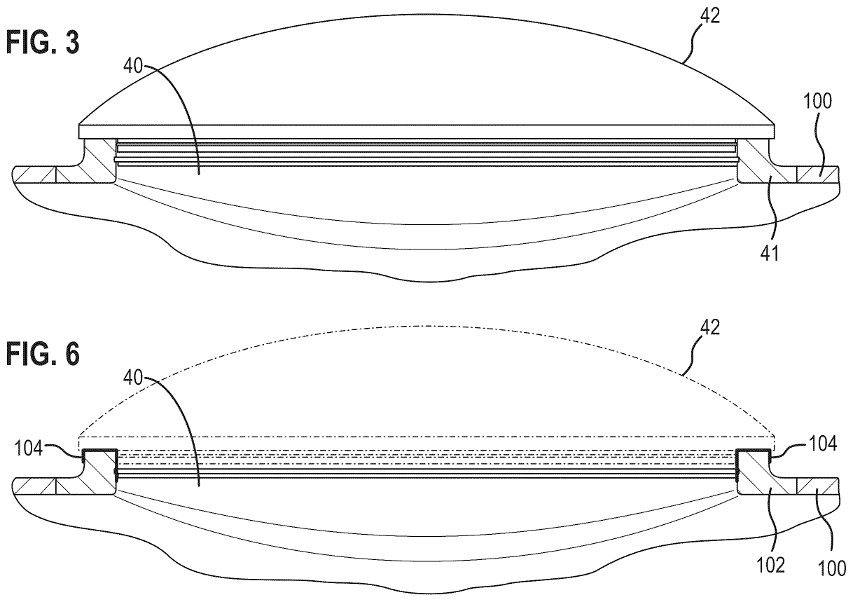

FIG. 3 shows a cross-section of an aperture fitting 41 integral with the hull wall 100. That is, the aperture fitting 41 is formed of one-piece with the rest of the hull wall 100 as the result of a single additive manufacturing process and there is no material join between the aperture fitting and the hull wall 100; they are one and the same. This integral formation of the aperture fitting 41 with the hull wall 100 eliminates the need for welding and the geometrical distortion it induces by the application of heat, thereby increasing the structural integrity and safety of the pressure hull. This process ensures that the beads of material deposited by the print head run continuously from the hull wall into the aperture fitting, resulting in a seamless and structurally sound connection between the two components. The integral formation of the aperture fittings with the hull wall also allows for the accurate positioning and alignment of the fittings, ensuring proper fit and function of the aperture components.

Alternatively, the hull wall 100 and the aperture fittings 41 are formed separately and then welded together. For example, one or both of the hull wall 100 and the aperture fitting 41 are formed by the additive manufacturing processes (e.g., WAAM) described herein, which at least allows the favourable distribution of global residual stresses to accrue in one or both components individually.

FIG. 3 shows that the aperture fitting 41 protrudes outwardly from the curved surface of the hull wall. Moreover, the aperture fitting 41 provides a flat (i.e., planar) ring-shaped structure which an aperture component can be fitted to. A window 42 is depicted in this figure. However, various different components can be fitted to the aperture fitting 41 such as hatches, and connecting structures configured to connect to an aperture fitting of a second pressure hull and to allow human passage therebetween. The ring-shaped surface allows for the easy integration of various aperture components, providing versatility and customization of the pressure hull 1. Where the pressure hull 1 is that of an underwater habitat, this versatility allows for the customization and expansion of the underwater habitat, as well as the integration of various equipment and systems necessary for the operation and maintenance of the habitat. In some variants, the aperture fitting 41 may also protrude radially inwardly, for example, where additional strengthening of the vessel is required at the apertures.

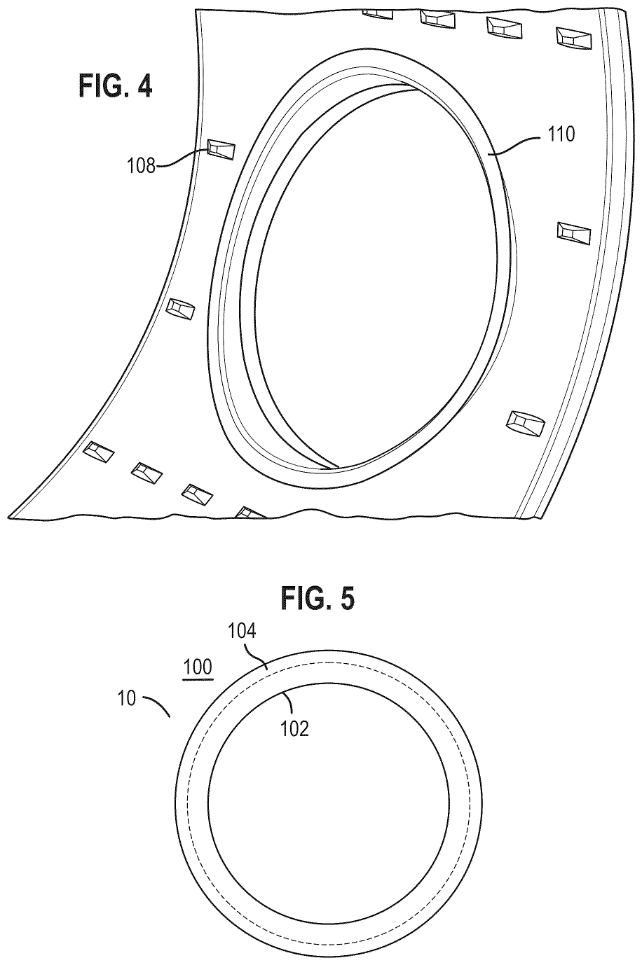

FIG. 4 presents a cross-section of a hull wall 100 showing an aperture 40. The hull wall 100 at the location of the aperture is strengthened against pressure loads by a reinforcing rib 110, thereby increasing the strength of the pressure hull. Like the aperture fitting 41, the rib 110 is formed integrally with the hull wall 100 in a single additive manufacturing process. Alternatively, the rib 110 may be welded on after the hull wall 100 is complete.

FIG. 4 also shows that the inside of the hull wall 100 also includes bosses 108 for attachment of internal components, such as equipment and fittings used to operate the pressure hull. These bosses 108 are also formed integrally with the hull wall by the same additive manufacturing process. Compared to welding bosses on to the wall in a separate step, the additive manufacturing approach enables the bosses to be positioned and aligned more accurately with each other. Although not shown, mounting strips for attaching external components such as ballast are formed in the outer surface of the hull wall 100 in a similar manner to the bosses 108, that is, in the same additive manufacturing process as the hull wall 100.

FIG. 5 displays a cross-section of the hull wall 100, comprising an inner layer 102 and an outer layer 104. It is understood here that the terms inner layer and outer layer do not necessarily coincide with layers of material as deposited in the additive manufacturing process (although they may). Instead, these terms refer to first and second regions of the hull wall.

The inner layer 102 is made of a first material, such as steel, titanium, or aluminium, and provides structural support for the pressure hull. These materials are known for their high strength, durability, and resistance to deformation under pressure, making them suitable for use in underwater applications. The inner layer 102 provides the primary structural support for the pressure hull, ensuring the safety and integrity of the underwater habitat. The radial thickness of the inner layer 102 is at least 15 mm, providing sufficient strength to withstand the external pressure experienced in underwater environments. In some applications designed for shallow use only, the radial thickness of the inner layer 102 may be as low as 8 mm.

The outer layer 104 is made of a second, different material, such as a corrosion-resistant material. The use of a corrosion-resistant material for the outer layer 104 helps protect the pressure hull from the corrosive effects of seawater and other underwater environments, thereby prolonging the service life of the pressure hull and reducing maintenance requirements. The outer layer 104 may also contribute to the structural support of the pressure hull, further enhancing its strength and durability. The radial thickness of the outer layer 104 may be at least 10 mm, ensuring adequate protection against corrosion while also contributing to the overall structural support of the pressure hull. In other words, the outer layer is not merely a thin coating that makes no contribution to the structural support of the pressure hull. Alternatively, the outer layer is made as a thin coating of 3-5 mm thickness where it does not contribute to the structural support.

The corrosion-resistant material used for the outer layer 104 may comprise Inconel. Inconel is a family of nickel-based superalloys known for their excellent corrosion resistance, high strength, and resistance to oxidation at elevated temperatures. The use of Inconel for the outer layer 104 provides a robust barrier against corrosion, making it suitable for underwater applications such as submarines and underwater habitats. The use of Inconel as the outer layer material further enhances the durability and longevity of the pressure hull. In one particular example, Inconel 625 is used. Alternatively, Duplex (1.4462) Steel or Super Duplex (1.4507) Steel may be used.

Both the inner layer 102 and the outer layer 104 are manufactured using additive manufacturing techniques.

FIG. 6 demonstrates an aperture 40 in a hull wall 100. The aperture fitting 41 is made of an inner layer 102 and an outer layer 104. The inner layer 102 provides structural support for the pressure hull, while the outer layer 104, made of a corrosion-resistant material like Inconel, protects the pressure hull from corrosion and contributes to its structural support. In some cases the outer layer 104 does not cover the entire outside of the pressure hull, but is located only in those places that are particularly vulnerable to corrosion or wear, such as the aperture fittings 41. Both the inner layer 102 and the outer layer 104 are manufactured using additive manufacturing techniques. The outer layer 104 may, in a finishing step of the manufacturing process, be machined back into a precise surface structure to allow accurate mating with aperture components. The inner and outer layers 102, 104, have the same properties as described for FIG. 5.

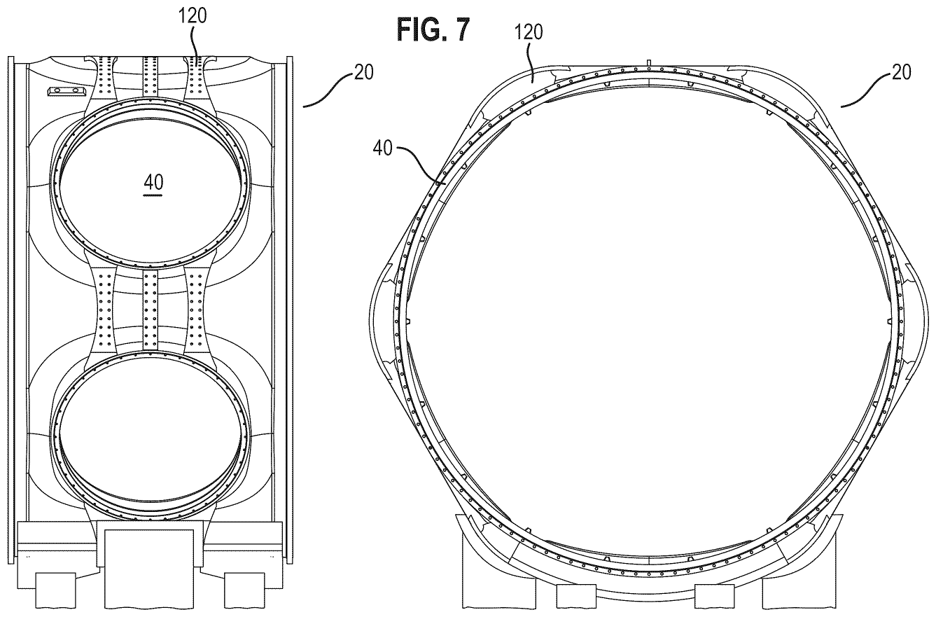

FIG. 7 depicts hull stiffeners 120 attached to the hull wall 100, between aperture fittings 41 by welding. The pressure hull 1 comprises a plurality of aperture fittings arranged 41 around the circumference of the pressure hull. The hull stiffeners 120 provide additional structural support to the pressure hull. In particular, under pressure, pairs of adjacent apertures 40 apply a bending force on the hull wall 100 between them. The hull stiffeners 120 are, therefore, attached to the hull wall and braced against the protruding aperture fittings 41 to counteract this force, thereby stiffening and strengthening the hull wall. Generally, three hull stiffeners 120 are provided between each adjacent aperture, however, different numbers may be used. Generally, the hull stiffeners 120 are attached to the outer surface of the hull wall 100. However, they may be provided on an inner surface of the hull wall 100 instead and/or they may be positioned on an outer surface and run around the entire circumference of the hull wall 100 at an axial position where no aperture fittings 41 are present.

The hull stiffeners 120 are welded in place. However, it should be noted that welding here is not detrimental, since the welds are not formed through the thickness of the hull wall, thereby comprising its strength.

The hull stiffeners 120 are not made during the same additive manufacturing process as the hull wall 100 and aperture fittings 41. This is because the apertures are T-shaped and, therefore, include large overhangs. Such shapes are difficult to create using additive manufacturing unless scaffolding is used, which increases manufacturing time and increases material wastage since the scaffolds must subsequently be machined away. Therefore, the hull stiffeners 120 are manufactured in a separate process and welded to the hull wall 100 in a subsequent step.

The hull stiffeners 120 can themselves be manufactured using additive manufacturing, such as WAAM, or forging techniques and are welded to the outer surface of the hull wall 100 after the additive manufacturing process of the hull wall is complete. This post-processing attachment of the hull stiffeners 120 allows for a more efficient additive manufacturing process, as it reduces the material waste that would typically be required for additive manufacturing scaffolding and avoids the need for large overhangs in the additive manufacturing process.

The hull stiffeners may be made of various materials, such as steel, which offers strength and durability suitable for underwater pressure hull applications. Duplex steel is preferred since it provides additional corrosion resistance and improved mechanical properties compared to traditional steel materials. For example, Duplex (1.4462) Steel or Super Duplex (1.4507) Steel may be used.

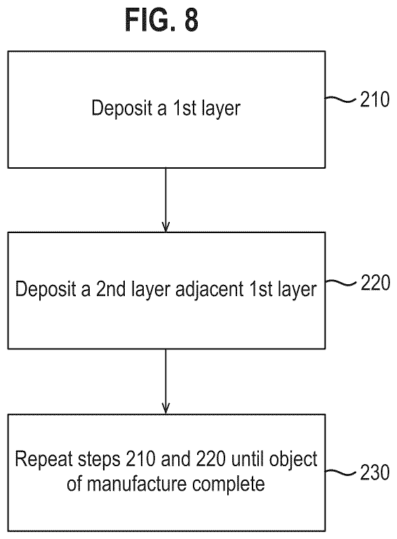

FIG. 8 is a flowchart illustrating a method 200 of manufacturing an object using additive manufacturing. The object may be the hull wall 100 of the pressure hull 1. The first step 210 involves depositing a first bead of a first material, such as steel, aluminium, or titanium, to form a portion of the object. The second step 220 involves depositing a second bead of a second material, which can be different from or the same as the first material, adjacent to the first bead to form another portion of the object. “Adjacent to” means “on top of” or “side-by-side” (i.e., at a same vertical height in the workpiece). The third step entails repeating steps 210 and 220 until the object is complete. It will be understood that first and second beads refer to the beads deposited during the additive manufacturing process and do not necessarily coincide with the inner and outer layers mentioned previously. One or more beads may make up the inner and outer layers.

The method of manufacturing a pressure hull using additive manufacturing may involve the integration of aperture fittings 41 with the hull wall 100 during the additive manufacturing process. The aperture fittings 41 may be formed integrally with the hull wall 100 in a single additive manufacturing process, eliminating the need for welding and the geometrical distortion it induces by the application of heat. This increases the structural integrity and safety of the pressure hull. The aperture fittings 41 may protrude outwardly from the hull wall 100 and may bound an aperture 40 in the hull wall 100. Alternatively, the hull wall 100 and the aperture fittings 41 are formed separately by additive manufacturing (e.g. WAAM) and then welded together. This at least allows the favourable distribution of global residual stresses to accrue in one or both components individually.

In some examples, the method of manufacturing a pressure hull using additive manufacturing may also involve the formation of bosses 108 on the inner surface of the hull wall 100 for attachment of internal components, such as equipment and fittings. These bosses 108 may be formed by the additive manufacturing process at the same time as forming the hull wall 100, allowing for accurate positioning and alignment with other bosses and reducing the need for additional welding or attachment processes.

The method of manufacturing a pressure hull using additive manufacturing may involve post-processing and finishing steps to further enhance the structural integrity and performance of the pressure hull. One such step may include the integration of hull stiffeners 120 between each pair of adjacent aperture fittings 41 after the additive manufacturing process by welding. The hull stiffeners 120 may be attached to the outer surface of the hull wall 100 and may provide additional structural support to the pressure hull, increasing its strength and durability.

The attachment of hull stiffeners 120 after the additive manufacturing process may help to avoid large overhangs in the additive manufacturing process, which can lead to material waste. The hull stiffeners 120 may be manufactured using additive manufacturing or forging techniques, depending on the specific requirements and design considerations of the pressure hull.

Overall, the method of manufacturing a pressure hull using additive manufacturing provides a versatile and efficient approach to creating structurally sound and durable pressure hulls for human occupancy in underwater habitats. The integration of various components and features, such as aperture fittings, hull stiffeners, and bosses, as well as the use of multiple layers and different materials in the hull wall, contribute to the enhanced performance and functionality of the pressure hull.

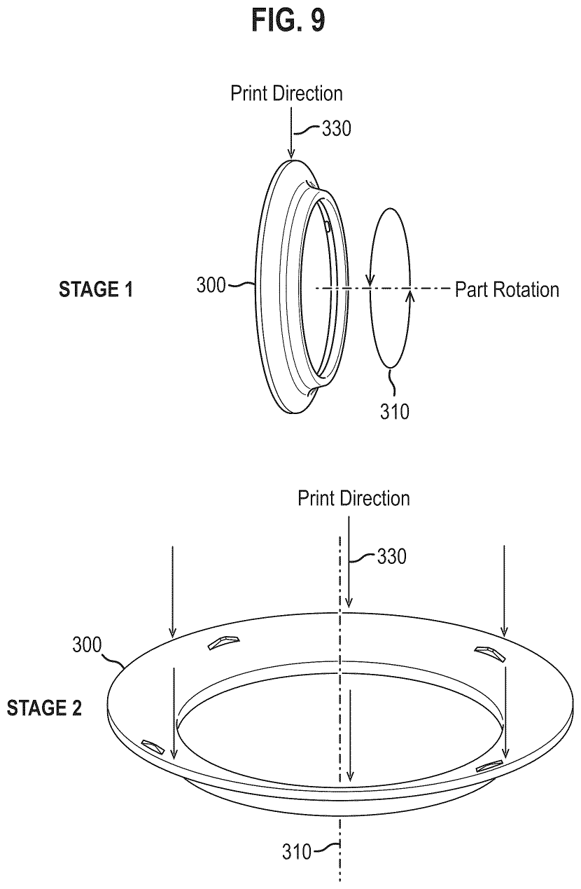

FIG. 9 shows steps in the forming of an end-cap module 10. The end-cap modules are shaped as hemispheres or torispheres, which are challenging to form in a simple additive manufacturing process where the printing direction and the orientation of the workpiece remain constant throughout. In that case, the hemispherical structure requires the printing large overhangs at some stage during the processing. In the first step, the axis of symmetry 310 of the workpiece is orientated horizontally, the workpiece is rotated about the axis and the material is deposited in a vertically downwards print direction 330 from the print head (the welding torch where a WAAM process is used). In the second step, the partially complete workpiece is rotated such that the axis of symmetry 310 is orientated vertically whilst printing is subsequently continued the vertically downwards print direction 330, a method of printing an end-cap module 10 is shown. This method allows for the end-cap module 10 to be formed using additive manufacturing techniques whilst avoiding printing of excessive overhangs.

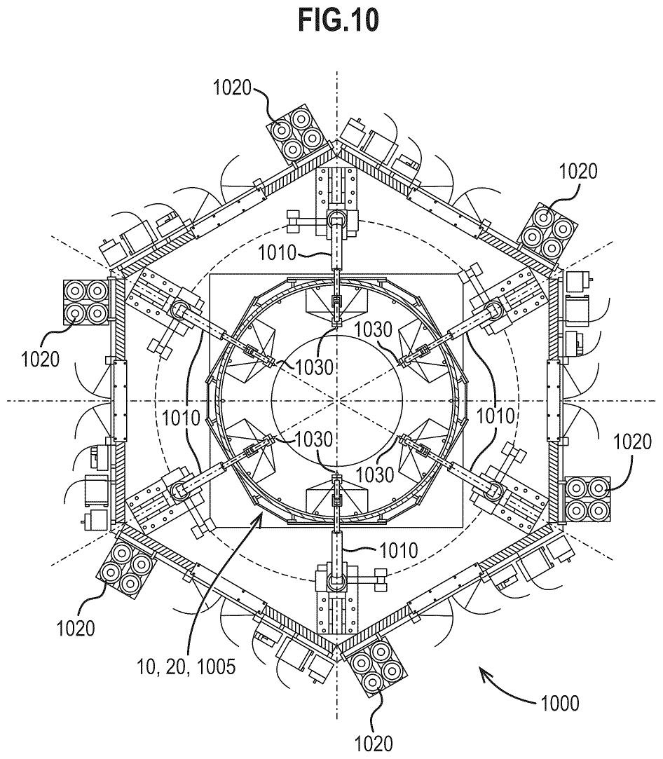

FIG. 10 shows a system 1000 for additively manufacturing a modular component of the pressure hull 1. In this case, a WAAM process is achieved by arranging a plurality of robotic arms 1010 having welding torches 1030 at their ends around the circumference of a hull wall section 10, 20. There may be as few as two robotic arms 1010 or as many as twelve. The welding torches 1030 are mounted at the ends of the robotic arms 1010. Welding wire 1020 is fed to the torches 1030 for depositing on the workpiece 1005. The robotic arms 1010 and torches 1030 are controlled to print the hull section 10, 20. Each welding torch deposits a bead of material along a line that extends around a partial angular section of the hull wall 10, 20. As a result, the hull wall 10, 20 is formed additively layer by layer vertically up the workpiece 1005. Subsequent beads (of the same or different materials) may be deposited vertically on top of, or horizontally beside an existing bead.

In one mode of operation, the bases of the robotic arms 1010 and the workpiece 1005 are stationary (as opposed to the workpiece 1005 being continuously rotated about its longitudinal axis). As a result, each robotic arm 1010 is configured to control its torch 1030 to weld the respective angular section of the workpiece. All robotic arms are controlled to operate together at the same time in parallel to weld their corresponding angular section of the hull wall 10, 20, such that the hull wall is continuously formed by multiple torches 1030 operating at the same time. Each angular section welded by each torch partially overlaps on top of the previous layer of those of its adjacent torches. That is, the beads/layers welded by each torch overlap with each other to ensure a strong, seamless (i.e., without a join) transition between the angular sections welded by each torch 1030.

The detailed description provided above demonstrates various aspects and features of the disclosed technology. The pressure hull for human occupancy, manufactured using additive manufacturing techniques, offers increased structural integrity and safety for occupants. The integral aperture fittings and hull stiffeners further enhance the strength and durability of the pressure hull. The use of multiple layers and different materials in the hull wall allows for improved corrosion resistance and structural support. The described method of manufacturing the pressure hull using additive manufacturing techniques enables the creation of complex shapes and structures with reduced material waste and increased accuracy.

### Advantages and Applications of WAAM in Pressure Hull Manufacturing

The use of the WAAM process in pressure hull manufacturing offers several advantages, including more favourable stress distributions and the absence of welds. The continuous deposition of material during the WAAM process results in a pressure hull with more favourable stress distributions, reducing the risk of potential points of failure. This increased structural integrity and safety for the occupants of the underwater habitat are in high-pressure environments.

Furthermore, the WAAM process allows for the formation of integral structures, such as aperture fittings, bosses, and reinforcing ribs, during the manufacturing process. This eliminates the need for welds (and the associated geometrical distortion welding induces by the application of heat), further enhancing the structural integrity of the pressure hull. The integral formation of these structures also simplifies the manufacturing process and reduces material waste, as there is no need for additional components to be manufactured separately and then attached to the pressure hull.

The pressure hull may comprise multiple layers of different materials, such as an inner layer of steel, titanium, or aluminium, and an outer layer of a corrosion-resistant material like Inconel, Duplex Steel, or Super Duplex Steel. The WAAM process enables the deposition of these different materials in a controlled and precise manner, ensuring that the pressure hull has the desired properties and performance characteristics.

Additionally, the WAAM process allows for the manufacturing of complex shapes and structures, such as cylindrical or spherical hull walls, bosses for attachment of internal components, and reinforcing ribs for apertures. These complex shapes and structures may be difficult or impossible to manufacture accurately using traditional methods, such as casting or forging, making the WAAM process a valuable tool in the construction of pressure hulls for human occupancy.

In summary, the use of additive manufacturing techniques, such as the Wire Arc Additive Manufacturing (WAAM) process, in the construction of pressure hulls for human occupancy offers several advantages in terms of structural integrity, material efficiency, and design flexibility. The continuous deposition of material during the WAAM process results in a pressure hull with more favourable stress distributions and the absence of welds in the hull wall itself, ensuring increased structural integrity and safety for the occupants of the underwater habitat. The integral formation of structures, such as aperture fittings, bosses, and reinforcing ribs, during the manufacturing process simplifies the manufacturing process and reduces material waste. Furthermore, the WAAM process enables the deposition of multiple layers of different materials, providing the pressure hull with the desired properties and performance characteristics.

It will be understood that the above description of is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the scope of this invention.

### EMBODIMENTS

The following list provides numbered embodiments of the invention and forms part of the description. These embodiments can be combined in any compatible combination beyond those expressly stated. The embodiments can also be combined with any compatible features described herein:

Example 1: A pressure hull for human occupancy manufactured by an additive manufacturing process.

Example 2: The pressure hull of example 1, wherein the pressure hull comprises a hull wall and at least one aperture fitting formed integrally with the hull wall.

Example 3: The pressure hull of example 2, wherein the at least one aperture fitting is formed as one piece with the hull wall in a single additive manufacturing process.

Example 3a: The pressure hull of example 1, wherein the pressure hull comprises a hull wall and at least one aperture fitting welded to the hull wall.

Example 4: The pressure hull of any one of examples 2 to 3a, wherein the at least one aperture fitting protrudes outwardly from the hull wall.

Example 5: The pressure hull of any one of examples 2 to 4, wherein the at least one aperture fitting bounds an aperture in the hull wall.

Example 6: The pressure hull of example 4 or example 5, wherein the at least one aperture fitting comprises a plurality of aperture fittings, wherein the pressure hull further comprises hull stiffeners, at least one arranged between each pair of adjacent aperture fittings, wherein the hull stiffeners are welded to an outer surface of the hull wall.

Example 7: The pressure hull of example 6, wherein the aperture fittings are arranged around a circumference of the pressure hull.

Example 8: The pressure hull of any one of examples 2 to 7, wherein at least one aperture fitting comprises a ring-shaped surface configured to be fitted with an aperture component.

Example 9: The pressure hull of example 8, wherein the aperture component is one of a window, a blank, a hatch, a moonpool, penetrator plate, penetrator, or a connecting structure configured to connect to an aperture fitting of a second pressure hull and to allow human passage therebetween.

Example 10: The pressure hull of any one of examples 1 to 9, wherein the pressure hull comprises a hull wall comprising an inner layer and an outer layer coating at least a portion of the inner layer, wherein the inner layer comprises a first material and the outer layer comprises a second, different material.

Example 11: The pressure hull of example 10, wherein the inner layer has a radial thickness of at least 8 mm or at least 30 mm.

Example 12: The pressure hull of example 10 or 11, wherein the outer layer has a radial thickness of at least 3 m or at least 10 mm.

Example 13: The pressure hull of any one of examples 10 to 12, wherein the first material comprises at least one of steel, titanium, or aluminium.

Example 14: The pressure hull of any one of examples 10 to 13, wherein the second material comprises a corrosion-resistant material.

Example 15: The pressure hull of example 14, wherein the corrosion-resistant material comprises Inconel, Duplex Steel, or Super Duplex Steel.

Example 16: The pressure hull of any one of examples 10 to 15, wherein both the inner layer and the outer layer are configured to support the pressure hull structurally against an applied pressure.

Example 17: The pressure hull of any one of examples 10 to 16, wherein both the inner layer and the outer layer are manufactured by the additive manufacturing process.

Example 18: The pressure hull of any one of examples 10 to 17, wherein the outer layer coats an entire surface of the inner layer or wherein the outer layer coats the inner layer at the aperture fittings.

Example 19: The pressure hull of any one of examples 1 to 18, wherein the pressure hull comprises a hull wall having a radial thickness of at least 40 mm.

Example 20: The pressure hull of example 19, wherein the radial thickness is between 50 mm and 80 mm.

Example 21: The pressure hull of any one of examples 1 to 20, wherein the pressure hull has an internal diameter of at least 1 m.

Example 22: The pressure hull of any one of examples 1 to 21, wherein the pressure hull comprises a hull wall having a cylindrical or spherical shape, wherein the cylindrical shape comprises hemispherical ends or torispherical ends.

Example 23: The pressure hull of any one of examples 1 to 22, wherein pressure hull comprises at least three hull wall modules connected in series to enclose an interior volume of the pressure hull.

Example 24: The pressure hull of any one of examples 1 to 23, wherein the additive manufacturing process is a wire arc additive manufacturing process.

Example 25: A method of manufacturing a pressure hull for human occupancy by an additive manufacturing process.

Example 26: The method of example 25, comprising depositing a first bead of a first material to form a portion of a hull wall of the pressure hull.

Example 27: The method of example 26, wherein the first material comprises at least one of steel, aluminium, or titanium.

Example 28: The method of example 26 or 27, further comprising depositing a second bead of a second material adjacent to the first bead to form a portion of the structural wall of the pressure hull.

Example 29: The method of example 28, wherein the second material is different from the first material.

Example 30: The method of example 28 or 29, wherein the second material is the same as the first material.

Example 31: The method of any one of examples 28 to 30, wherein the second material is a corrosion-resistant material.

Example 32: The method of example 31, wherein the corrosion-resistant material is Inconel Duplex Steel, or Super Duplex Steel.

Example 33: The method of any one of examples 25 to 32, wherein the pressure hull comprises a hull wall and the method further comprises forming an aperture fitting integrally with the hull wall in a single manufacturing process.

Example 33a: The method of any one of examples 25 to 32, wherein the pressure hull comprises a hull wall and the method further comprises forming an aperture fitting separately from the hull wall and, subsequently, welding the aperture fitting to the hull wall.

Example 34: The method of example 33 or example 34, wherein the at least one aperture fitting protrudes outwardly from the hull wall.

Example 35: The pressure hull of any one of examples 33 to 34, wherein the at least one aperture fitting bounds an aperture in the hull wall.

Example 36: The method of any one of examples 33 to 35, further comprising: forming a plurality of the aperture fittings; and integrating hull stiffeners between each pair of adjacent aperture fittings after the additive manufacturing process by welding.

Example 37: The method of example 36, wherein the aperture fittings are arranged around a circumference of the pressure hull.

Example 38: The method of any one of examples 33 to 37, wherein at least one aperture fitting comprises a ring-shaped surface configured to be fitted with an aperture component.

Example 39: The pressure hull of example 38, wherein the aperture component is one of a window, a blank, a hatch, a moonpool, penetrator plate, penetrator, or a connecting structure configured to connect to an aperture fitting of a second pressure hull and to allow human passage therebetween.

Example 40: The method of any one of examples 25 to 39, wherein the additive manufacturing technique is Wire Arc Additive Manufacturing (WAAM).

Example 41: A pressure hull for human occupancy manufactured by the method according to any one of examples 25 to 40.

Example 42: A method of additive manufacturing comprising: depositing, by an additive manufacturing process, a first metal; and depositing, by the same additive manufacturing process, a second metal different from the first metal abutting the deposited first metal.

Example 43: The method of example 42, wherein the additive manufacturing process comprises wire arc additive manufacturing.

Example 44: The method of example 42 or 43, wherein the second metal is a corrosion-resistant metal.

Example 45: The method of example 44, wherein the corrosion-resistant metal comprises Inconel, Duplex Steel, or Super Duplex Steel.

Example 46: The method of any one of examples 42 to 45, wherein the first metal comprises steel, aluminium, or titanium.

Example 47: The method of example 40 or 43, comprising using a plurality of welding torches, each mounted on an end of a robotically controlled arm, and arranged circumferentially around a workpiece.

Example 48: The method of example 47, wherein each torch is controlled to deposit one or more beads to thereby form an angular section of the workpiece, and wherein the one or more beads deposited by each torch at least partially overlap with one or more beads deposited by an adjacent torch such that the angular sections formed by each torch overlap and are seamlessly connected.

1. A pressure hull for human occupancy manufactured by an additive manufacturing process.

2. The pressure hull according to claim 1, wherein the pressure hull comprises a hull wall and at least one aperture fitting formed integrally with the hull wall.

3. The pressure hull according to claim 2, wherein the at least one aperture fitting is formed as one piece with the hull wall in a single additive manufacturing process.

4. The pressure hull according to claim 1, wherein the pressure hull comprises a hull wall and at least one aperture fitting welded to the hull wall.

5. The pressure hull according to claim 2, wherein the at least one aperture fitting protrudes outwardly from the hull wall.

6. The pressure hull according to claim 2, wherein the at least one aperture fitting bounds an aperture in the hull wall.

7. The pressure hull according to claim 6, wherein the at least one aperture fitting comprises a plurality of aperture fittings, wherein the pressure hull further comprises hull stiffeners, at least one arranged between each pair of adjacent aperture fittings, wherein the hull stiffeners are welded to an outer surface of the hull wall.

8. The pressure hull according to claim 7, wherein the aperture fittings are arranged around a circumference of the pressure hull.

9. The pressure hull according to claim 2, wherein at least one aperture fitting comprises a ring-shaped surface configured to be fitted with an aperture component.

10. The pressure hull according to claim 9, wherein the aperture component is one of a window, a blank, a hatch, a moonpool, penetrator plate, penetrator, or a connecting structure configured to connect to an aperture fitting of a second pressure hull and to allow human passage therebetween.

11. The pressure hull according to claim 1, wherein the pressure hull comprises a hull wall comprising an inner layer and an outer layer coating at least a portion of the inner layer, wherein the inner layer comprises a first material and the outer layer comprises a second, different material.

12. The pressure hull according to claim 11, wherein the inner layer has a radial thickness of at least 8 mm or at least 30 mm.

13. The pressure hull according to claim 11, wherein the outer layer has a radial thickness of at least 3 mm or at least 10 mm.

14. The pressure hull according to claim 11, wherein the first material comprises at least one of steel, titanium, or aluminium.

15. The pressure hull according to claim 11, wherein the second material comprises a corrosion-resistant material.

16. The pressure hull according to claim 15, wherein the corrosion-resistant material comprises Inconel, Duplex Steel, or Super Duplex Steel.

17. The pressure hull according to claim 11, wherein both the inner layer and the outer layer are configured to support the pressure hull structurally against an applied pressure.

18. The pressure hull according to claim 11, wherein both the inner layer and the outer layer are manufactured by the additive manufacturing process.

19. The pressure hull according to claim 11, wherein the outer layer coats an entire surface of the inner layer or wherein the outer layer coats the inner layer at the aperture fittings.

20. The pressure hull according to claim 1, wherein the pressure hull comprises a hull wall having a radial thickness of at least 40 mm.

21. The pressure hull according to claim 20, wherein the radial thickness is between 50 mm and 80 mm.

22. The pressure hull according to claim 1, wherein the pressure hull has an internal diameter of at least 1 m.

23. The pressure hull according to claim 1, wherein the pressure hull comprises a hull wall having a cylindrical or spherical shape, wherein the cylindrical shape comprises hemispherical ends or torispherical ends.

24. The pressure hull according to claim 1, wherein pressure hull comprises at least three hull wall modules connected in series to enclose an interior volume of the pressure hull.

25. The pressure hull according to claim 1, wherein the additive manufacturing process is a wire arc additive manufacturing process.

26-47. (canceled)
